(19) United States
(12) Patent Application Publication
(10) Pub. No.: US 2016/0378270 A1
(43) Pub. Date: Dec. 29, 2016

(54) METHOD FOR PROVIDING USABILITY NOTIFICATION FOR EXTENDABLE AREA OF DISPLAY AND ELECTRONIC DEVICE SUPPORTING THE SAME

(71) Applicant: Samsung Electronics Co., Ltd., Gyeonggi-do (KR)

(72) Inventors: Olivia LEE, Seoul (KR); Ju Eun LEE, Seoul (KR); Soon Kyu JANG, Gyeonggi-do (KR); Jin Mi CHOI, Seoul (KR)

(73) Assignee: Samsung Electronics Co., Ltd.

(21) Appl. No.: 15/180,504

(22) Filed: Jun. 13, 2016

(30) Foreign Application Priority Data
Jun. 24, 2015 (KR) 10-2015-0089557

(51) Int. Cl. G06F 3/0481; G06F 3/0484; G06F 1/16

(52) U.S. Cl. CPC G06F 3/0481; G06F 1/1652; G06F 3/04842; G06F 2203/04803

(57) ABSTRACT

An electronic device is provided that includes a flexible display having a deformable form, a processor electrically connected to the display, and a memory electrically connected to the processor, and the processor is configured to display a notification object that provides notification about an existence of information, which is to be displayed on at least a part of a second area of the display expanded according to deformation of the display when an event occurs, on a first area corresponding to an area before expansion of the display.

### PRIORITY

This application claims priority under 35 U.S.C. §119(a) to Korean Patent Application Serial No. 10-2015-0089557 which was filed on Jun. 24, 2015, in the Korean Intellectual Property Office, the entire content of which is incorporated herein by reference.

### BACKGROUND

1. Field of the Disclosure

The present disclosure generally relates to a method for providing a usability notification for an extendable area of a display.

2. Description of the Related Art

Flexible displays that may be bent, folded, or rolled have gained popularity. Further, electronic devices utilizing the flexible displays and their related technologies have been actively developed. In particular, a method for changing a display area that may be generated by deforming the flexible display is becoming an important factor in utilizing the flexible display.

The conventional method for changing a display area focuses on a change in an interface that detects an external change of a form factor and the provision of information through the interface, in relation to the deformation of the flexible display. Accordingly, the user cannot recognize what information will be output in an expandable area of the flexible display first.

### SUMMARY

The present disclosure has been made to address at least the above-mentioned problems and/or disadvantages and to provide at least the advantages described below. Accordingly, an aspect of the present disclosure is to provide a method for outputting a notification object that provides notification that information, which is to be output in an expandable area of a display when a designated event occurs, is present in a designated area of the display, and an electronic device supporting the method.

Another aspect of the present disclosure is to provide a method for outputting a notification object based on a type of an event, a type and a number of output information, or an expansion direction and an expansion degree of the display, and an electronic device supporting the method.

According to an aspect of the present disclosure, an electronic device includes a flexible display having a deformable form, a processor electrically connected to the display, and a memory electrically connected to the processor, and the memory may store instructions that allows the processor to output a notification object that provides notification that information, which is to be output to at least a part of a second area of the display expanded according to deformation of the display when an event occurs, is present in a first area corresponding to an area before expansion of the display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to various embodiments of the present disclosure;

FIG. 2 illustrates a processor related to a method for providing a notification according to various embodiments of the present disclosure;

FIG. 3 illustrates a notification object according to various embodiments of the present disclosure;

FIG. 4A is a view illustrating a notification providing function on a flexible display that is expanded in a portrait view according to various embodiments of the present disclosure;

FIG. 4B is a view illustrating a notification providing function on a flexible display that is expanded in a landscape view according to various embodiments of the present disclosure;

FIG. 4C is a view illustrating a notification providing function on a flexible display that is foldable according to various embodiments of the present disclosure;

FIG. 5 is a flowchart of a method for managing an electronic device related to a method for providing a notification according to various embodiments of the present disclosure;

FIG. 6 illustrates a notification object that is varied based on the expansion degree of the display according to various embodiments of the present disclosure;

FIG. 7 illustrates information, which is to be output in an expandable area when the display is expanded according to various embodiments of the present disclosure;

FIG. 8 illustrates additional information, which is to be output in an expandable area when the display is expanded according to various embodiments of the present disclosure;

FIG. 9A illustrates a notification object that is provided when a selection input event of an item included in a list, among the user input events, is generated according to various embodiments of the present disclosure;

FIG. 9B illustrates a notification object that is provided when a selection input event of a designated function, among the user input events, is generated according to various embodiments of the present disclosure;

FIG. 10 illustrates a notification object provided in relation to execution of a designated application according to various embodiments of the present disclosure;

FIG. 11 illustrates a notification object provided when a communication event occurs according to various embodiments of the present disclosure; and

FIG. 12 illustrates a notification object provided when a system event occurs according to various embodiments of the present disclosure.

Throughout the drawings, similar reference numbers are used to depict similar elements, features, and structures.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein may be made without departing from the scope and spirit of the present disclosure. With regard to description of drawings, similar components may be marked by similar reference numerals.

In the present disclosure, the expressions “have”, “may have”, “include” and “comprise”, or “may include” and “may comprise” used herein indicate the existence of corresponding features (e.g., elements such as numeric values, functions, operations, or components) but do not exclude the presence of additional features.

In the present disclosure, the expressions “A or B”, “at least one of A or/and B”, or “one or more of A or/and B”, and the like used herein may include any and all combinations of one or more of the associated listed items. For example, the terms “A or B”, “at least one of A and B”, or “at least one of A or B” may refer to all of the cases (1) where at least one A is included, the case (2) where at least one B is included, or the case (3) where both of at least one A and at least one B are included.

Terms, such as “first”, “second”, and the like used herein may refer to various elements of embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening elements (e.g., a third element).

According to the situation, the expression “configured to” as used herein may be used interchangeably with, for example, the expressions “suitable for”, “having the capacity to”, “designed to”, “adapted to”, “made to”, or “capable of”. The term “configured to (or set to)” does not mean only “specifically designed to” in hardware. Instead, the expression “a device configured to” may mean that the device is “capable of” operating together with another device or other components. A CPU, for example, a “processor configured to (or set to) perform A, B, and C” may mean a dedicated processor (e.g., an embedded processor) for performing a corresponding operation or a general-purpose processor (e.g., a central processing unit (CPU) or an application processor) which may perform corresponding operations by executing one or more software programs which are stored in a memory device.

Terms used in this specification are used to describe specified embodiments of the present disclosure and do not limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. The wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disk (DVD) player, an audio player, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller machine (ATM), a point of sales (POS) terminal, an Internet of Things (IoT) device (for example, a light bulb, various sensors, an electricity or gas meter, a spring cooler device, a fire alarm device, a thermostat, an electric utility pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device may be a flexible electronic device. Further, the electronic device is not limited to the aforementioned devices, but may include new electronic devices produced due to the development of new technologies.

Hereinafter, electronic devices according to an embodiment of the present disclosure will be described with reference to the accompanying drawings. The term “user” as used herein may refer to a person who uses an electronic device or may refer to a device (for example, an artificial intelligence device) that uses an electronic device.

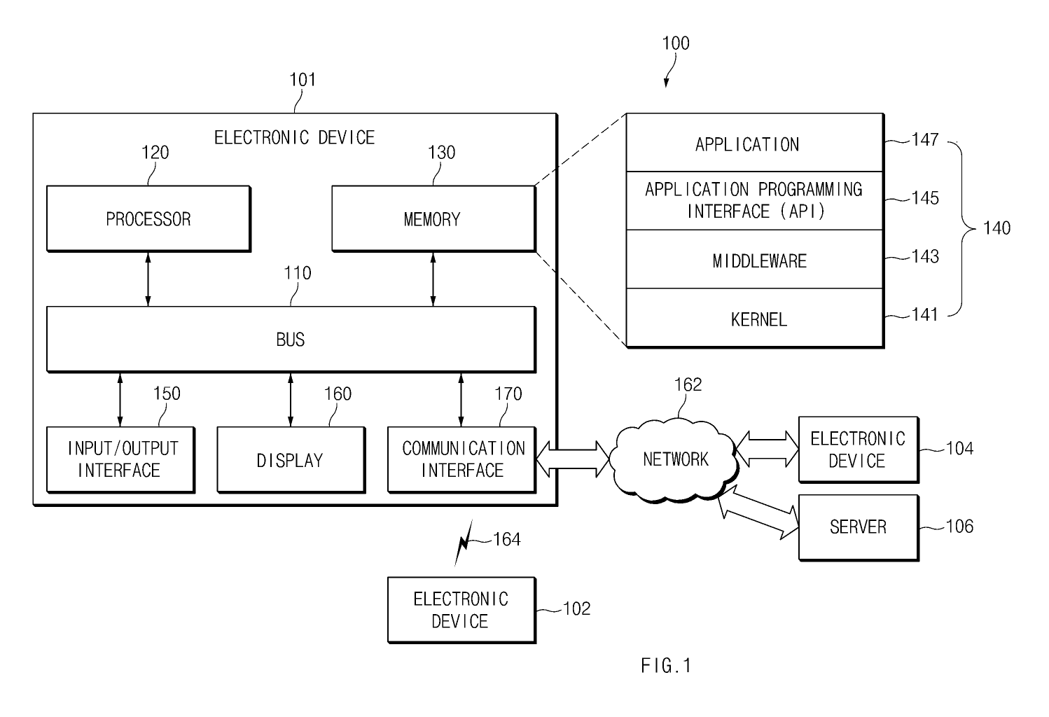

FIG. 1 illustrates an electronic device in a network environment according to various embodiments.

The electronic device 101 according to various embodiments may output a notification object that provides notification that information, which is to be output in an expandable area of a display 160 in response to a designated event, is present. For example, if a user input event, a communication event, or a system event occurs (or is generated), the electronic device 101 may generate a notification object having a designated width and a designated height and output the generated notification object in a designated area of a display area before expansion of the display 160. A color, a border, a shape, and a transparency of the notification object or a color, a background color, a border, a shape, a size, or the number of indication objects included in the notification object may be different so that the content of the information, which is to be output, may be different.

Referring to FIG. 1, the electronic device 101 includes a bus 110, a processor 120, a memory 130, an input/output interface 150, a display 160, and a communication interface 170. In some embodiments, the electronic device 101 may exclude at least one of the elements or may additionally include other elements.

The bus 110 may include, for example, a circuit that connects the components 110 to 170 and transfers communications (for example, control messages and/or data) between the components.

The processor 120 may include one or more of a central processing unit (CPU), an application processor (AP), or a communication processor (CP). The processor 120, for example, may execute operations or data processing related to the control and/or communication of at least one other component of the electronic device 101. According to an embodiment, the processor 120 may process signals related to provision of a user notification for an expandable area of the display 160. For example, the processor 120 may allow a notification object that provides notification that information, which is to be output in an expandable area of the display 160 when a designated event occurs, is present in a designated area of the display 160.

The memory 130 may include volatile and/or nonvolatile memories. The memory 130, for example, may store a command or data related to at least one other component of the electronic device 101. According to an embodiment, the memory 130 may store instructions or data related to provision of a user notification for an expandable area of the display 160. For example, the memory 130 may contain an instruction that processes an event (or a command (input signal)) related to provision of a notification, an instruction that generates a notification object in response to the event, an instruction that outputs the generated notification object in a designated area of the display 160, or an instruction that outputs information in an expandable area of the display 160 if a designated user input for the notification object is generated. The instruction may be executed by the processor 120.

According to an embodiment, the memory 130 may store software and/or a program 140. The program 140 includes a kernel 141, middleware 143, an application programming interface (API) 145, and/or an application program (or an application) 147. At least some of the kernel 141, the middleware 143, or the API 145 may be referred to as an operating system (OS).

The kernel 141, for example, may control or manage system resources (for example, the bus 110, the processor 120, and the memory 130) that are used to execute operations or functions implemented in the other programs (for example, the middleware 143, the API 145, or the applications 147). The kernel 141 may provide an interface through which the middleware 143, the API 145, or the applications 147 access individual components of the electronic device 101 to control or manage the system resources.

The middleware 143, for example, may function as an intermediary that allows the API 145 or the applications 147 to communicate with the kernel 141 to exchange data.

The middleware 143 may process one or more work requests received from the application programs 147, according to their priorities. For example, the middleware 143 may give a priority, by which a system resource (for example, the bus 110, the processor 120, or the memory 130) of the electronic device 101 may be used, to at least one of the application programs 147. For example, the middleware 143 may perform scheduling or load balancing for the one or more work requests by processing the one or more work requests according to the priority given to the application programs 147.

The API 145 is an interface used, by the application 147, to control a function provided by the kernel 141 or the middleware 143, and may include, for example, at least one interface or function (for example, an instruction), for example, for file control, window control, image processing, and text control.

The input/output interface 150, for example, may function as an interface that may transfer a command or data that are input from the user or another external device to another component(s) of the electronic device 101. The input/output interface 150 may output a command or data received from another component(s) of the electronic device to the user or anther external device 101.

According to various embodiments, the input/output interface 150 may transfer a command (or an input signal) or data input by the user through an input unit such as a touch panel, a physical button, a keypad, or a microphone to the processor 120. A command or data input by the user may be mapped as a user input event by the processor 120, and may be classified differently according to the type of the command or data and information contained in the a command or data. For example, the user input event may be classified into a touch input event, a gesture input event, a key input event, or a button input event based on the input method thereof. Further, the user input event may be classified into an information input event that inputs a text (or letter), a number, a symbol, or a gesture in a selected input field, and a selection input event that selects a designated display object from at least one display object (or a user interface (UI) component (for example, an icon, a list, or a button)) output on the display 160 based on the input purpose thereof. The input/output interface 150 may provide information for the user through an output unit such as an audio unit, such as a speaker or an earphone, which processes an audio signal.

The display 160, for example, may include a liquid crystal display (LCD), a light emitting diode (LED) display, an organic light emitting diode (OLED) display, a microelectromechanical system (MEMS) display, or an electronic paper display. The display 160, for example, may display various content (for example, a text, an image, a video, an icon, and a symbol) to the user. The display 160 may include a touch screen and receive, for example, a touch, a gesture, a proximity, or a hovering input using an electronic pen or a part of the user's body.

According to various embodiments, the display 160 may include a flexible display. For example, a part of the display 160 may be bent, folded, or rolled. The display 160 may divide a screen into a plurality of areas. For example, the display 160 may divide the screen based on a change in form factor according to a deformation of a form. The display 160 may designate a display area of the screen in the state in which at least a part of the display 160 is bent, folded, or rolled as a first area, and may designate the other display area, that is, an area in which the screen is expanded as the at least a part of the display 160 is unfolded as a second area. The display 160 may divide the second area into a plurality of areas. For example, the display 160 may divide the second area into a plurality of areas having a designated width and a designated height.

The communication interface 170, for example, may set communication between the electronic device 101 and an external device (for example, a first external electronic device 102, a second external electronic device 104, or a server 106). For example, the communication interface 170 may be connected to a network 162 through a wireless communication or a wired communication to communicate with the external device (for example, the second external electronic device 104 or the server 106). According to various embodiments, the communication interface 170 may transfer a command or data received from the external device to the processor 120 while the electronic device 101 communicates with the external device. The command (input signal) or data transmitted or received while the electronic device 101 communicates with the external device may be mapped as a communication event by the processor 120.

The wireless communication is, for example, a cellular communication protocol, and, for example, may use at least one of long-term evolution (LTE), LTE-advanced (LTE-A), code division multiple access (CDMA), wideband CDMA (WCDMA), a universal mobile telecommunications system (UMTS), wireless broadband (WiBro), or a global system for mobile communications (GSM). Furthermore, the wireless communication, for example, may include a short range communication 164. The short range communication 164, for example, may include at least one of wireless fidelity (Wi-Fi), Bluetooth, a near field communication (NFC), or a global navigation satellite system (GNSS). The GNSS may include at least one of, for example, a global positioning system (GPS), a global navigation satellite system (Glonass), a Beidou navigation satellite system (Beidou), or the European global satellite-based navigation system (Galileo), according to a use area or a bandwidth. Hereinafter, in the present disclosure, the term “GPS” may be interchangeably used with the term “GNSS”. The wired communication may include at least one of, for example, a universal serial bus (USB), a high definition multimedia interface (HDMI), recommended standard-232 (RS-232), and a plain old telephone Service (POTS). The network 162 may include at least one of communication networks, for example, a computer network (for example, a LAN or a WAN), the Internet, or a telephone network.

The first and second external electronic devices 102 and 104 may be the same or different type devices from the electronic device 101. According to an embodiment, the server 106 may include a group of one or more servers. All or some of the operations executed by the electronic device 101 may be executed by another or a plurality of electronic devices 102, 104 or the servers 106. When the electronic device 101 executes some functions or services automatically or upon request, it may request at least some functions associated with the functions or services from another device 102, 104 or the server 106, in place of, or in addition to, directly executing the functions or services. The other electronic device may execute a requested function or an additional function, and may transfer the result to the electronic device 101. The electronic device 101 may process the received result directly or additionally, and may provide a requested function or service. To this end, for example, the cloud computing, distributed computing, or client-server computing technologies may be used.

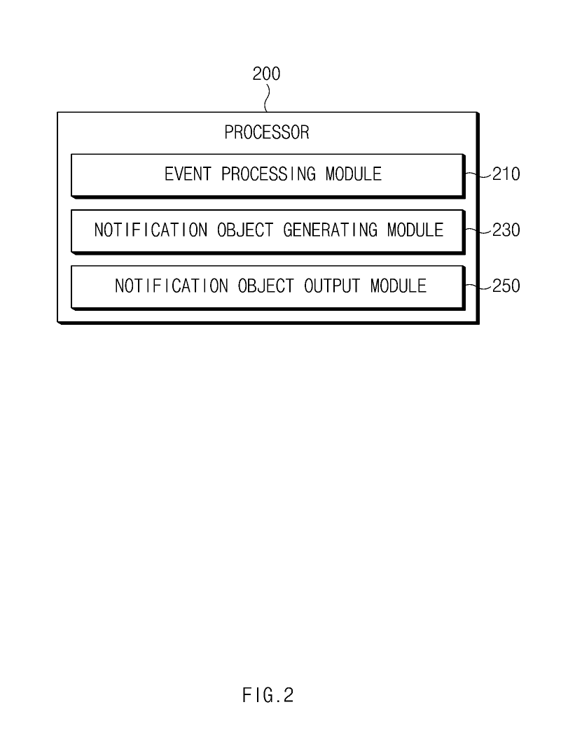

FIG. 2 illustrates a processor related to a method for providing a notification according to various embodiments.

Referring to FIG. 2, the processor 200 includes an event processing module 210, a notification object generating module 230, and a notification object output module 250. FIG. 2 illustrates only main elements of the processor 200 to describe functions related to the method for providing a notification. The elements of the processor 200 are not limited thereto. According to various embodiments, the processor 200 may additionally include at least one element, and in some embodiments, the processor 200 may exclude at least one of the elements. The processor 200 may have a configuration that is similar to or the same as the processor 120 of FIG. 1.

The event processing module 210 may process an event generated by an electronic device 101. The event processing module 210 may map a command (or an input signal) transferred to the processor 200 as a corresponding event. For example, the event processing module 210 may map a command or data input by the user as a user input event, and may map a command or data transmitted or received while the electronic device 101 communicates with an external electronic device connected in a wired/wireless scheme as a communication event. Further, the event processing module 210 may map a command or data input from a platform (or an operating system) of the electronic device as a system event.

The user input event may include an information input event that inputs information such as a text (or letter), a number, a symbol, or a gesture to a selected input field through an input method such as a touch input, a gesture input, a key input, or a button input, and a selection input event that selects a designated display object from at least one display object displayed on a screen. The communication event may be classified into a signal transmission event related to transmission of data to an external electronic device, and a signal reception event related to reception of data from an external electronic device. Further, the communication event may be classified into a voice communication event, a text communication event, an image communication event, or an image communication event according to the type of data (or the type of a communication service). The system event may include control events of various system resources (for example, the bus 110, the processor 120, the memory 130, the input/output interface 150, the display 160, or the communication interface 170 illustrated in FIG. 1) constituting a platform or connected to a platform. For example, the system event may include a calculation processing event, a file control event, a window control event, an image processing event, or a text control event. The system event may include a connection (or function activation)/control event of a unit (for example, a camera) included in at least one functional module (for example, a camera module) implemented on a platform.

According to various embodiments, the event processing module 210 may process an event (hereinafter, a notification providing event) related to provision of a user notification for an expandable area of the display 160. The notification providing event may include a selection input event of a designated display object output on the display 160, a communication event that needs to be notified of the user, or a system event. If the notification providing event (or a command corresponding thereto) occurs (or is generated), the event processing module 210 may transfer information related to the notification providing event to the related system resources. For example, if the notification providing event occurs, the event processing module 210 may transfer the type of the notification providing event and information contained in the notification providing event to a notification object generating module 230.

According to various embodiments, when a form factor based on a deformation of the display 160 is changed, the event processing module 210 may map corresponding information (the size of the expandable area of the display 160) as a system event. Further, the event processing module 210 may transfer information related to the event to at least one of the notification object generating module 230 and the notification object output module 250.

The notification object generating module 230 may generate a notification object when the notification providing event occurs. According to various embodiments, the notification object generating module 230 may generate the notification object differently based on the type of the notification providing event, the type and number of information elements which is to be output in an expandable area of the display 160, or the expansion direction and degree of the display 160. For example, the notification object generating module 230 may generate at least one of the width and the height of the notification object differently. Further, the notification object generating module 230 may constitute a color, a border, a shape, and a transparency of the notification object, or a color, a background color, a border, a shape, a size, and a number of indication objects included in the notification object differently.

The notification object output module 250 may output the generated notification object in a designated area of the display 160. According to an embodiment, the notification object output module 250 may output the notification object in an area, which is close to a side on which the display 160 is expanded, on an edge of the display 160. For example, if a display area of the screen before the display 160 is expanded (for example, at least a part of the display 160 is bent, folded, or rolled) is a first area and an area that is generated by expanding the screen as the part of the display 160 is unfolded is a second area, the notification object output module 250 may output the notification object at a designated part of an area in which the first area and the second area are connected to each other, before a part of the display 160 is unfolded. The notification object output module 250 may output the notification object in an area, which is situated on a side on which the second area is expanded, on an edge of the second area, in a state in which a part of the display 160 is unfolded.

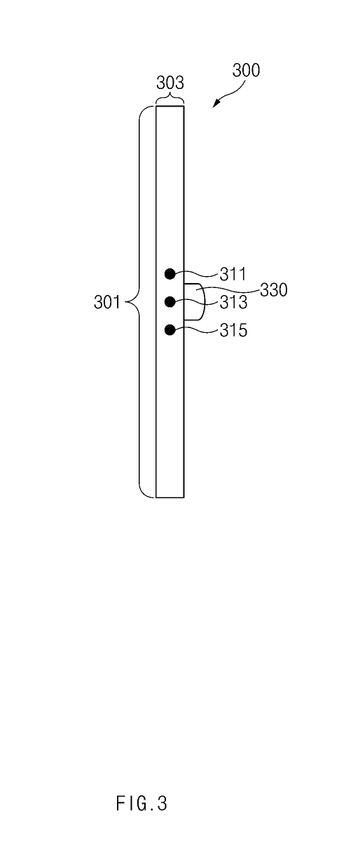

FIG. 3 illustrates a notification object according to various embodiments of the present disclosure.

Referring to FIG. 3, the notification object 300 may be a display object having a height 301 and a width 303. According to an embodiment, the height 301 or the width 303 of the notification object 300 may be defined by a length of an edge (or corner) on a side close to where the display 160 is expanded. For example, if the expansion direction of the display 160 is a longitudinal direction, the width 303 of the notification object 300 may be defined by a length that is the same as or similar to the transverse length of the display 160. For example, if the expansion direction of the display 160 is a transverse direction, the height 301 of the notification object 300 may be defined by a length that is the same as or the similar to the longitudinal length of the display 160.

According to various embodiments, the notification object 300 may include at least one indication object in a designated area. The indication object may be a display object that indicates information, which is to be output in an expandable area of the display 160. The number of the indication objects may be the same as the number of information elements, which are to be output in the expandable area. The drawing illustrates a form in which a first indication object 311, a second indication object 313, and a third indication object 315 are disposed at a central portion of the notification object 300. The indication objects may be a text, an image, or an icon. The indication object may be a dot image having a designated color. In some embodiments, the indication object may be an execution icon of an application corresponding to information, which is to be output in the expandable area.

According to various embodiments, the indication object may be configured differently based on the type of the notification providing event, the type and number of information elements, which are to be output in the expandable area, or the expansion direction and the degree of the display 160. For example, a color, a background color, a border, a shape, or a size of the indication object may be configured differently. Although the drawing illustrates that the first indication object 311, the second indication object 313, and the third indication object 315 have the same color, the same shape, and the same size, at least one of the color, the background color, the border, the shape, or the size of the indication object may be configured differently. As an example, when the first indication object 311, the second indication object 313, and the third indication object 315 are display objects that indicate a first application, a second application, and a third application, respectively, the indication objects may be execution icons of the corresponding applications. Further, the indication objects may be dot images designated by a representative color (for example, a widely used color) of an execution icon of the corresponding application.

According to various embodiments, the notification object 300 may not include the indication object. In this case, the color, the border, the transparency, or the shape of the notification object 300 may configured differently such that the notification object 300 performs the same or similar function. For example, the notification object 300 may be configured differently based on the type of the notification providing event, the type and number of information elements, which are to be output in the expandable area, or the expansion direction and the degree of the display 160. As an example, the notification object 300 may divide an area by the number of information elements, which are to be output in the expandable area, and express the colors of the areas such that the areas indicate different information elements. The notification object 300 may designate the colors of the areas as a representative color of the information elements which the areas indicate. In some embodiments, the notification object 300 may apply a gradient effect with the colors of the areas.

According to various embodiments, the notification object 300 may include an input area 330 that receives a user input for the notification object 300. The input area 330 may be a partial area of the notification object 300 that induces the user to perform a touch input or a gesture input for the notification object 300. The input area 330 may be an area that extends from a designated point of the notification object 300 in an expansion direction of the display 160 or in a direction opposite to the expansion direction of the display 160. The input area 330 may be configured by a color expressed at a designated point of the notification object 300. Further, the input area 330 may be configured by a color contrasted from a color of a peripheral area for securing visibility.

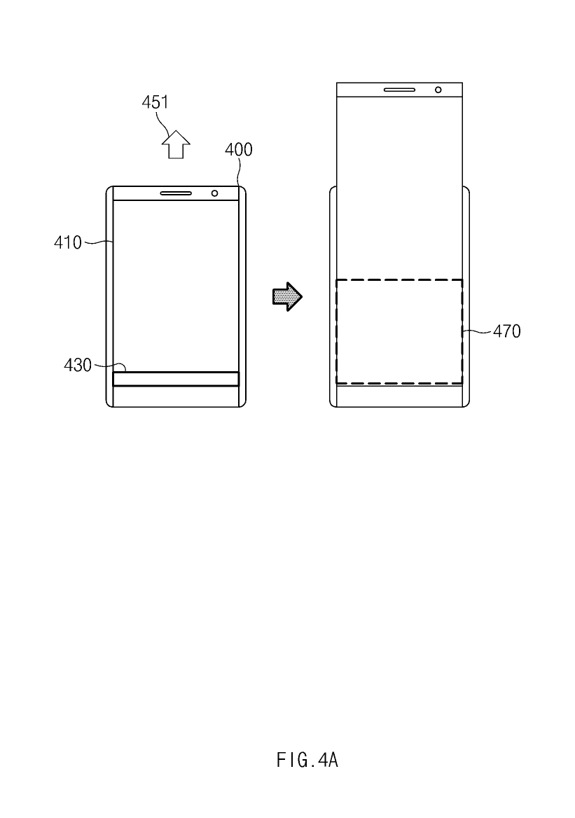

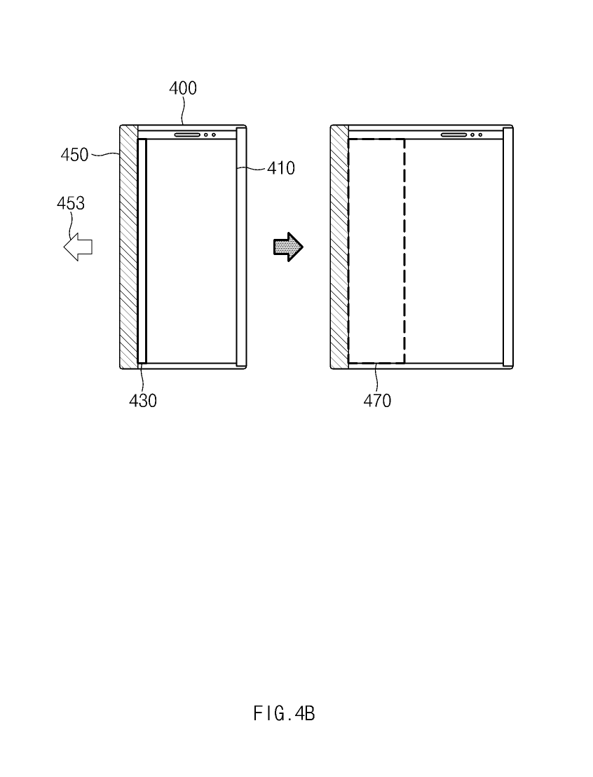

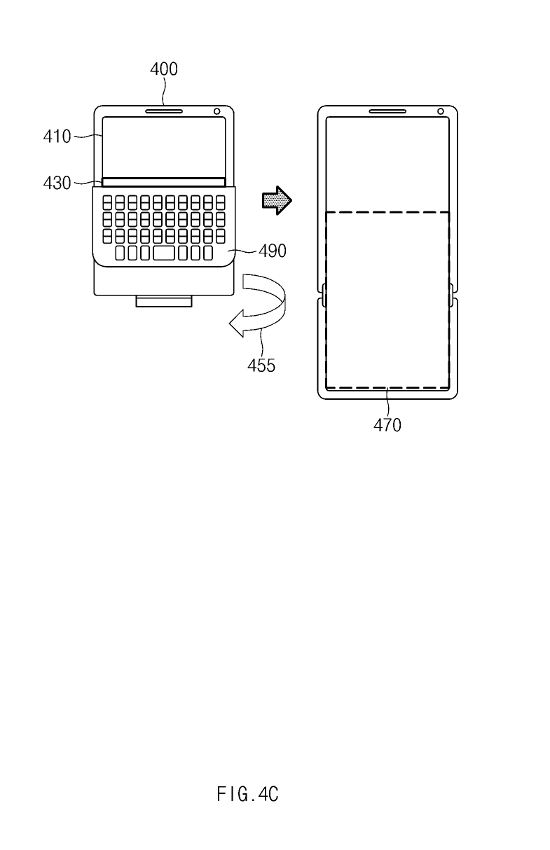

FIG. 4A is a view illustrating a notification providing function on a flexible display that is expanded in a portrait view according to various embodiments of the present disclosure.

Referring to FIG. 4A, the electronic device 400 may include a flexible display that is expanded in a portrait view. The electronic device 400 may utilize the first area 410 as a display area before the display is expanded in a portrait view. According to various embodiments, the electronic device may output the notification object 430 in a designated area of the display when a designated event occurs. The electronic device 400 may output the notification object 430 in an area, which is situated on a side close to a side on which the second area 470 of the display is expanded, on an edge of the first area 410. As shown in FIG. 4A, the electronic device 400 may output the notification object 430 in a designated area on an edge at a lower end of the first area 410. Further, the electronic device 400 may expand the second area 470 at a lower end of the first area 410 based on a display expanding in the upwards direction 451.

FIG. 4B is a view illustrating a notification providing function on a flexible display that is expanded in a landscape view according to various embodiments of the present disclosure.

Referring to FIG. 4B, the electronic device 400 may include a flexible display that is expanded in a landscape view. The display expanding operation in a transverse direction may be similar to the display expanding operation of FIG. 4A in a longitudinal direction. For example, before the display expanding operation in a transverse direction, the electronic device 400 may utilize the first area 410 as a display area before the display is expanded in a portrait view. Meanwhile, the notification object 430 may have a different area. For example, the electronic device 400 may output the notification object in a designated area on a left edge of the first area 430. Further, the electronic device 400 may expand the second area 470 at a left end of the first area 410 based on a display expanding in the leftwards direction 453. Although the drawing illustrates that the display is expanded leftwards, the present disclosure is not limited thereto. The display may be expanded rightwards.

According to various embodiments, the electronic device 400 may include a designated area of a bezel connected to the display as a gripping area 450 in relation to the expansion operation of the display. For example, the user may expand the display by gripping and pulling the gripping area 450. In some embodiments, the electronic device 400 may include a physical button on a designated area (for example, a side surface) to expand the display by pushing the physical button.

FIG. 4C is a view illustrating a notification providing function on a flexible display that is foldable according to various embodiments of the present disclosure.

Referring to FIG. 4C, in the electronic device 400, at least a part of the flexible display may be folded. According to various embodiments, in the electronic device 400, a keypad 490 may be disposed in a designated area of a rear surface of the display. Accordingly, while at least a part of the display is folded, the keypad 490 disposed on the rear surface of the display may face the front side of the display. As shown in FIG. 4C, in the electronic device 400, at least a part of the display is folded such that the first area 410 is utilized as a display area, and the keypad 490 may be situated at a lower end of the first area 410.

According to various embodiments, the electronic device 400 may output the notification object 430 in an area, which is situated on a side close to a side on which at least a part of the display is folded when the designated event occurs, on an edge of the first area 410. The notification object 430 represents a state in which the notification object 430 is output in an area on an edge at a lower end of the first area 410. Further, the electronic device 400 may expand the second area 470 at a lower end of the first area 410 based on an operation 455 of unfolding at least a part of the folded display.

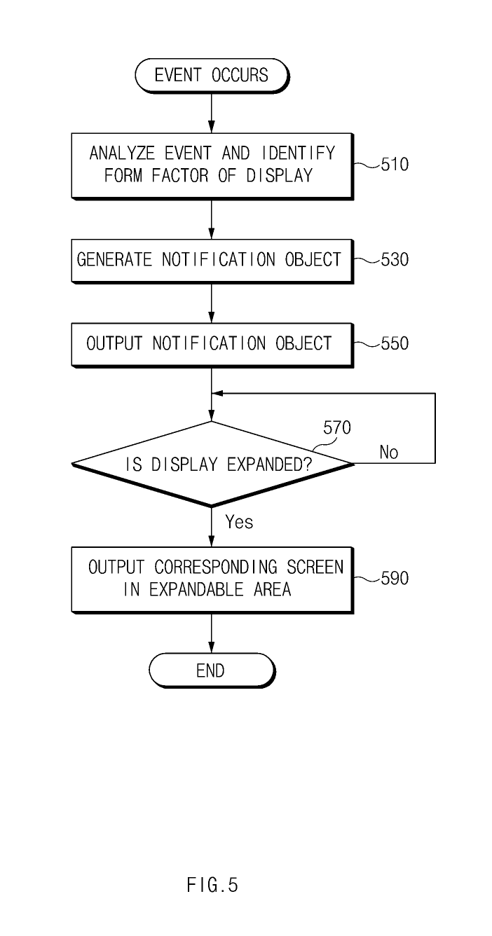

FIG. 5 is a flowchart of a method for managing an electronic device related to a method for providing a notification according to various embodiments of the present disclosure.

Referring to FIG. 5, in operation 510, an electronic device (for example, the electronic device 101 of FIG. 1) analyzes the event. For example, the electronic device may recognize the type of event and analyze information contained in the event. The information contained in the event may be different based on the type of the event. When the event is a user input event, the information may include an input method, an input time, or an input location (coordinate). When the event is a communication event, the information may include a communication target, a communication time, or communication data. When the event is a system event, the information may include system resource information, an event generation time, or control function information.

According to various embodiments, the electronic device may identify a form factor of the display (for example, the display 160 of FIG. 1). For example, the electronic device may identify a transverse length and a longitudinal length of the display. The electronic device may identify the size of a display area (for example, the first area 410 of FIG. 4A) before expansion of the display and the size of the expandable area (for example, the second area 470 of FIG. 4A).

In operation 530, the electronic device generates a notification object. According to various embodiments, the electronic device may differently generate the notification object based on the type of the event, the type and the number of information elements, which are to be output in the expandable area of the display, and the expansion direction and the expansion degree of the display. The electronic device may designate at least one of the width or the height of the notification based on a form factor of the display.

In operation 550, the electronic device output a notification object. According to various embodiments, the electronic device may output the notification object in a designated area, which is situated on a side close to a side on which the display is expanded, on an edge of a display area before expansion of the display. For example, the electronic device may output the notification object at a part of an area in which the display area before expansion of the display is connected to the expandable area.

In operation 570, the electronic device determines whether the display is expanded. According to various embodiments, the electronic device may determine whether the display is expanded and the degree of expansion if the display has been expanded, based on a sensor disposed in a designated area of the display or a designated area of a bezel connected to the display. The electronic device may include a proximity sensor or a flexible bending sensor to determine whether the display is expanded or the expansion degree. The proximity sensor may be a sensor that detects an object that approaches a designated detection surface or an object that is present in the vicinity of the detection surface. The proximity sensor may include an inductive type, a capacitive type, an ultrasonic type, a photoelectric type, or a magnetic type. For example, when the proximity sensor is a photoelectric proximity sensor, a light emitting diode or a photodiode may be disposed in a designated area of the display or a designated area of the bezel. The flexible bending sensor may be a bendable sensor, and may detect a resistance value that changes in proportion to the bending degree. The flexible bending sensor has a thin strip shape, and may be attached to a designated area of the rear surface of the display. The electronic device may determine whether the display is expanded, by determining whether a physical button that functions to expand the display is selected (for example, pushed).

According to various embodiments, when the display is not expanded, the electronic device may maintain an output state of the notification object. Further, when the output state of the notification object is maintained for a designated time or longer, the electronic device may terminate the output state of the notification object. When the display is expanded, in operation 590, the electronic device outputs a corresponding screen in the expandable area. For example, the electronic device may output, in the expandable area, output information indicated by an indication object included in the notification object. When the display is not expanded by a designated size or more, the electronic device may maintain the output of the notification object or may output a form, a color, and a transparency of the notification object or a type, a color, or a number of indication objects included in the notification object differently. If the display is expanded by a designated size or more, the electronic device may terminate the output of the notification object.

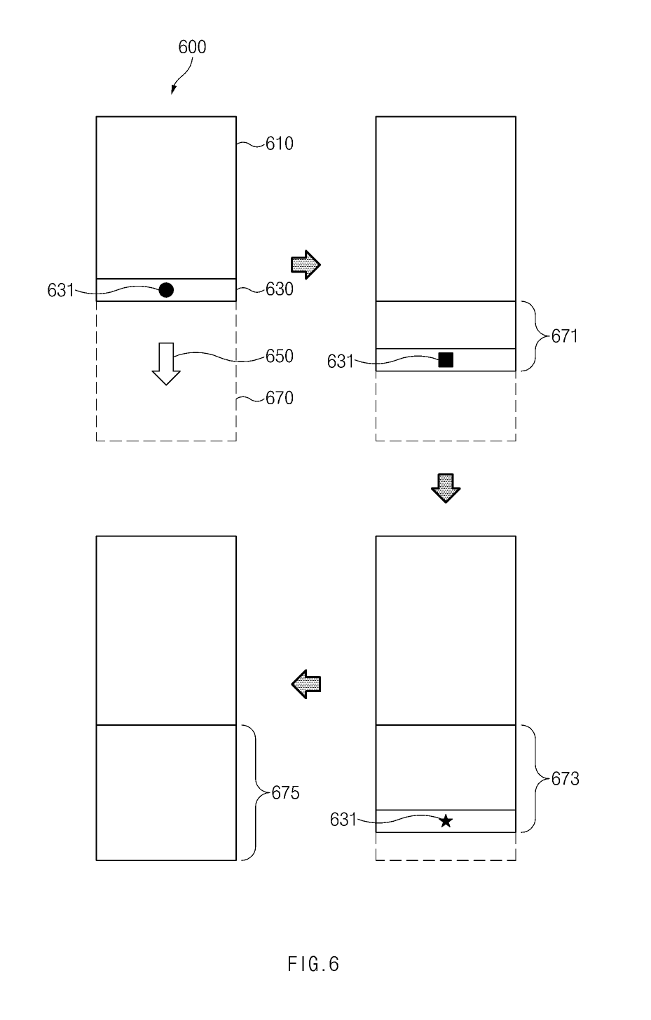

FIG. 6 illustrates a notification object that is different based on the expansion degree of the display according to various embodiments of the present disclosure.

Referring to FIG. 6, the electronic device 101 may include an expandable display 600. The display 600 may be divided into a first area 610 that is a display area before expansion of the display 600 and a second area 670 that is an expandable area. Although the drawing illustrates a form in which the second area 670 is disposed at a lower end of the first area 610, the form is a disposition form based on the expansion direction of the display 600 and the present disclosure is not limited thereto. In some embodiments, the second area 670 may be disposed at an upper end, a left end, or a right end of the first area 610. As another example, the display 600 may include a third area that another expansion area in addition to the second area 670. The third area may be disposed at an upper end, a left end, or a right end of the first area 610.

According to various embodiments, the electronic device may output the notification object 630 in a designated area of the first area 610 when a designated event occurs. The electronic device may output the notification object 630 in an area, which is situated on a side close to a side on which the expandable area of the display 600 is expanded, on an edge of the first area 610. In FIG. 6, the notification object 630 represents a state in which the notification object 430 is output in an area on an edge at a lower end of the first area 610.

According to various embodiments, the notification object 630 may include at least one indication object 631. The indication object 631 is a display object that indicates information, which is to be output in the second area 670, and may include a text, an image, or an icon. The electronic device may constitute the notification object 630 differently based on the expansion degree of the display 600. For example, the electronic device may constitute a color, a border, a shape, and a transparency of the notification object 630 or a color, a background color, a border, a shape, a size, or a number of the indication objects 631 differently based on the expansion degree of the display 600.

FIG. 6 illustrates that the electronic device constitutes the indication object 631 with a circular image when the notification object 630 is output before the display 600 is expanded. Further, the drawing illustrates that the display 600 is expanded by a first length 671 and a second length 673 such that the electronic device changes the indication object 631 with an image having a square shape and a star shape. According to various embodiments, the electronic device may output a corresponding screen in a designated area of the second area 670 as the display 600 is expanded. Further, the electronic device may constitute and output a color, a border, a shape, and a transparency of the notification object 630 or a color, a background color, a border, a shape, a size, and a number of the indication objects 631, differently based on information, which is not output in the second area 670 while the display 600 is not expanded by a designated size or more. If the display 600 is expanded by a designated size or more and the second area 670 is displayed in a designated size or more, the electronic device may terminate the output of the notification object 630.

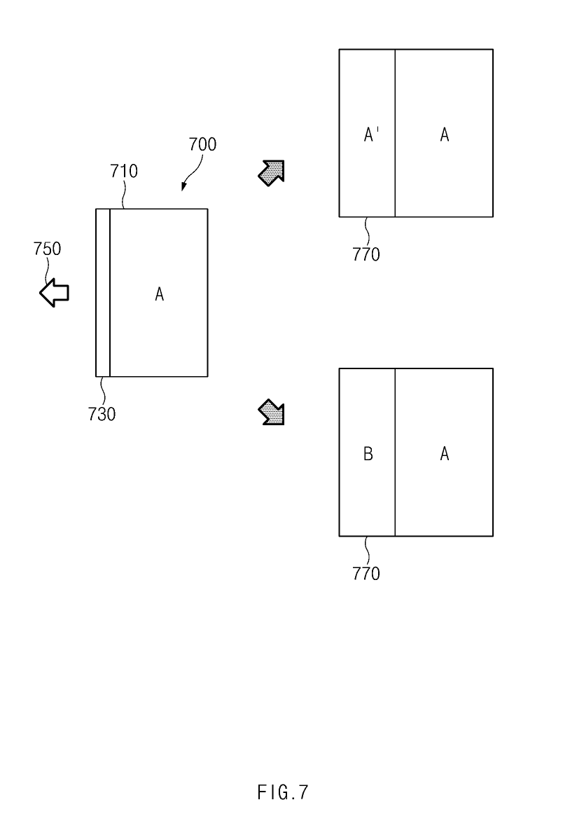

FIG. 7 illustrates information, which is to be output in an expandable area when the display is expanded according to various embodiments of the present disclosure.

Referring to FIG. 7, the electronic device 101 may output a first information element (for example, A task related information) in a first area 710 that is a display area before the expandable display 700 is expanded. According to various embodiments, the electronic device may output the notification object 730 in a designated area of the first area 710 when a designated event occurs. The notification object 730 may be differently constituted based on the type of the event, the type and the number of information elements, which are to be output in the second area 770 that is an expandable area, the expansion direction and the expansion degree of the display 700.

According to various embodiments, the electronic device may differently designate information, which is to be output in the second area 770, based on the type of the event and the information contained in the event. When the event is a selection input event in which a designated display object is selected from at least one display object, which is to be output in the first area 710, the electronic device may designate the content related to the selected display object as information, which is to be output in the second area 770. Further, when the event is a communication event or a system event, the electronic device may designate an execution screen of an application related to the communication event or the system event as information, which is to be output in the second area 770, regardless of the first information element output in the first area 710.

As shown in FIG. 7, the electronic device may output a second information element (for example, A′ task related information) related to a first information element in the second area 770 based on an operation 750 of expanding the display 700, or may output a third information element (for example, B task related information) regardless of the first information element. According to various embodiments, the first information element and the second information element may be different function executing screens of the same application. For example, the first information element may be a first function executing screen (for example, a received mail list display screen) of a first application (for example, a mail application), and the second information element may be a second function executing screen (for example, a content display screen of a designated item of the received mail list). Further, the first information element and the second information element may be function executing screens associated with different applications. For example, the first information element may be a third function executing screen (for example, a main writing screen) of a first application (for example, a mail application), and the second information element may be a fourth function executing screen (for example, a stored picture list display screen) of a second application (for example, a picture album application). For example, if an attached file adding function is selected from a mail writing screen, the electronic device may output an notification object 730 in a designated area of the first area 730 instead of outputting a picture list display screen of a picture album application in the first area 730, and may output a picture list display screen in the second area 770 based on the expansion operation 750 of the display 700.

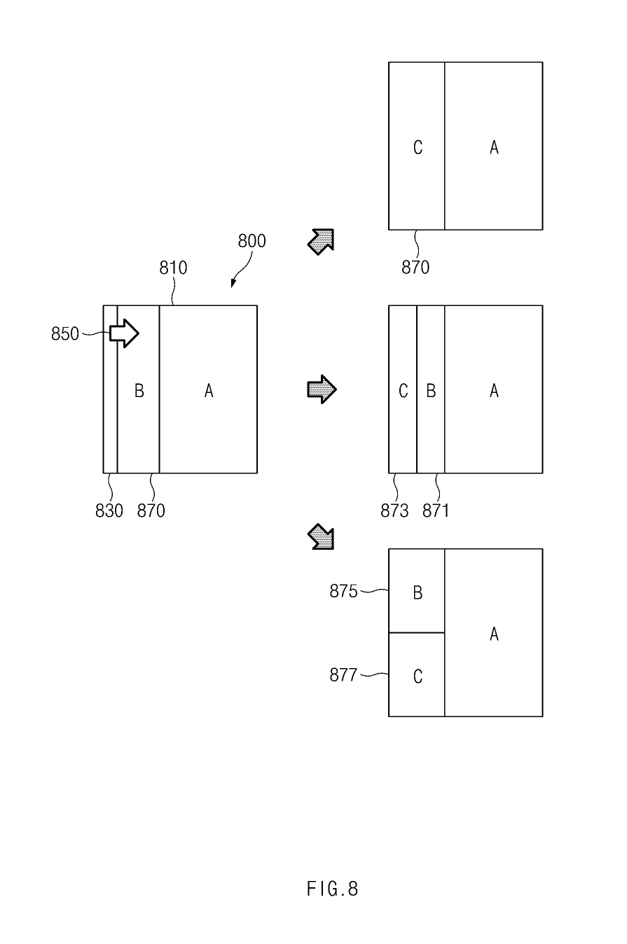

FIG. 8 illustrates additional information, which is to be output in an expandable area when the display is expanded according to various embodiments of the present disclosure.

Referring to FIG. 8, the electronic device 101 may output a notification object 830 while the display 800 is expanded by a designated size or more. For example, the electronic device may output the notification object 830 in a designated area of the first area 810 or the second area 870 when the designated event occurs while at least a part of the first area 810 and the second area 870 is utilized as a display area. Although FIG. 8 illustrates a state in which the notification object 830 is output in a designated area of the second area 870, according to various embodiments, the notification object 830 may be output in a designated area of the first area 810 or may be output over the first area 810 and the second area 870.

According to various embodiments, if a user input 850 for the notification object 830 is generated, the electronic device may divide the second area 870 into a plurality of areas. The user input 850 for the notification object 830 may include, for example, a touch input for the notification object 830 (for example, an input of touching a designated point of the notification object 830) or a gesture input (for example, an input of moving a designated point of the notification object 830 in a designated direction while the point of the notification object 830 is pushed). The electronic device may divide the second area 870 by at least one longitudinal border line. For example, the electronic device may divide the second area 870 into a third area 871 and a fourth area 873. Further, the electronic device may divide the second area 870 by at least one transverse border line. For example, the electronic device may divide the second area 870 into a fifth area 875 and a sixth area 873. The electronic device may divide the second area 870 by at least one longitudinal border line and at least one transverse border line.

According to various embodiments, the electronic device may output corresponding information of the divided areas when the user input 850 is generated. For example, if the user input 850 is generated while a first information element (for example, A task related information) is output in the first area 810 and a second information element (for example, B task related information) is output in the second area 870, the second information element is output in the third area 871 or the fifth area 875 and a third information element (for example, C task related information) that is additional information may be output in the fourth area 873 or the sixth area 877. According to various embodiments, the output areas of the second information element and the third information element may be differently designated by setting information of the electronic device. For example, the electronic device may output a second information element in the fourth area 873 or the sixth area 877, and may output a third information element in the third area 871 or the fifth area 875. The electronic device may terminate the output of the second information element in the second area 870 and output a third information element, instead of dividing the second area 870.

According to various embodiments, the third information may be content related to the first information element or the second information element, or may be new content that is irrelevant to the first information element or the second information element. The third information element may be different function executing screens of the same application as the first information element or the second information, or may function executing screens associated with different applications.

According to various embodiments, the electronic device may output the third information element in at least an area of the first area 810 instead of outputting the third information element in at least an area of the second area 870. In this case, the electronic device may divide the first area 810 into a plurality of areas having a designated width and a designated height.

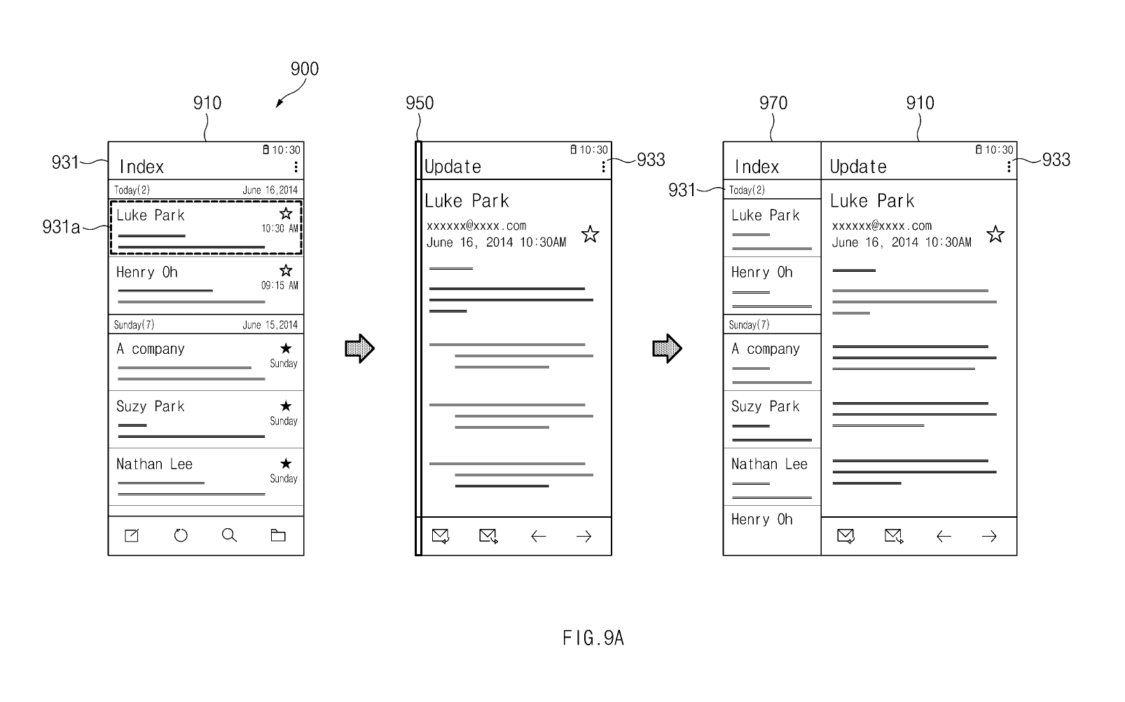

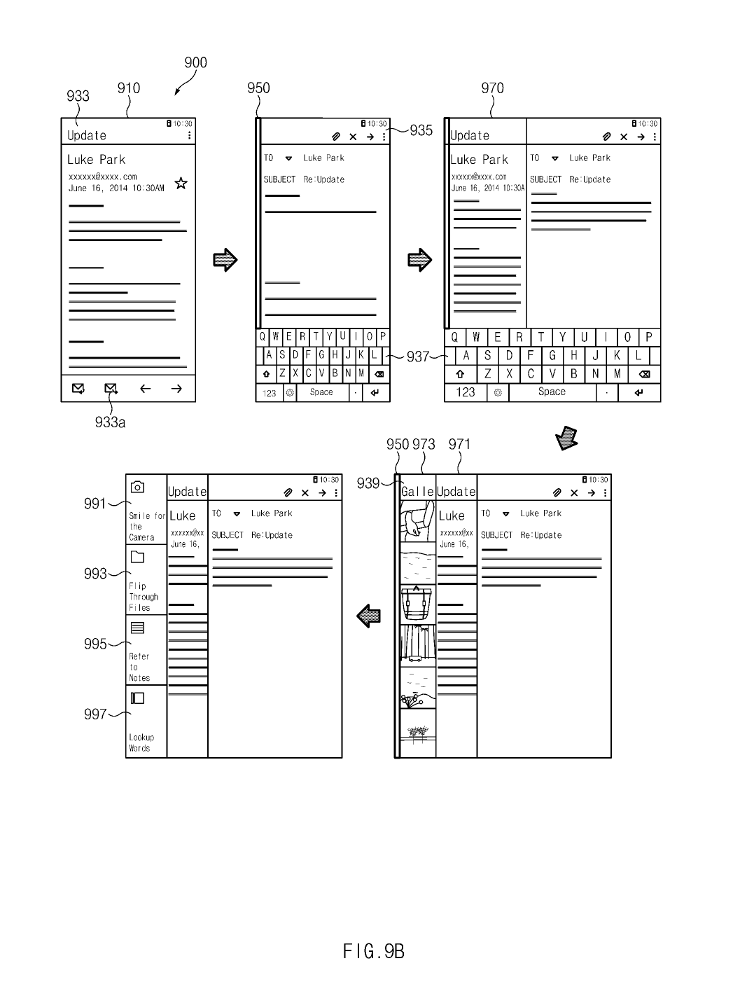

FIG. 9A illustrates a notification object that is provided when a selection input event of an item included in a list, among the user input events, is generated according to various embodiments of the present disclosure.

Referring to FIG. 9A, the electronic device 101 may output a list 931 constituted by at least one item in the first area 910 that is a display area before the display 900 is expanded. FIG. 9A illustrates a screen in which a list 931 produced as a designated function (for example, a received mail list display function) of the functions of a designated application (for example, a mail application) included in the electronic device is output in a first area 910.

According to various embodiments, the electronic device may output the notification object 950 in a designated area of the first area 910 when a selection input event of an item included in the list 931 is generated. If a designated item 931a of at least one item included in the list 931 is selected, the electronic device may terminate the output of the list 931 in the first area 910 and may output information 933 (for example, a receive main content) corresponding to the selected item 931a in the first area 910. Further, the electronic device may output the notification object 950 in a designated area of the first area 910. The electronic device may designate and generate at least one of the width and the height of the notification object 950 as the length of an edge on a side close to a side on which the display 900 is expanded. The drawing illustrates a view in which the expansion direction of the display 900 is set to a landscape view such that the height of the notification object 950 is the same as or similar to the longitudinal length of the display 900. The electronic device may constitute the color of the notification object 950 as a representative color of the selected item 931a.

According to various embodiments, if the display 900 is expanded, the electronic device may output information related to the information 933 corresponding to the selected item 931a in the second area 970 that is an expandable area. FIG. 9A illustrates a state in which the electronic device outputs a list 931 in the second area 970. In this state, if the user selects a designated item from the list 931 output in the second area 970, the electronic device may output information corresponding to the selected item in the first area 910.

Although FIG. 9A illustrates configurations of a list output screen and an information output screen corresponding to a selected item, the present disclosure is not limited thereto. According to various embodiments, the electronic device may configure a current execution screen and a previous execution screen in the aforementioned scheme. For example, the electronic device may output the current execution screen in the first area 910, and may output the previous execution screen in the second area 970. If a designated link included in a first webpage is selected, the electronic device may output content (for example, a text, an image, a video, or a second webpage) connected through the selected link in the first area 910 and may output the first webpage in the second area 970.

FIG. 9B illustrates a notification object that is provided when a selection input event of a designated function, among the user input events, is generated according to various embodiments of the present disclosure.

Referring to FIG. 9B, the electronic device 101 may output a first function executing screen 933 including at least one function object in the first area 910. The drawing illustrates a state in which a received mail content display screen illustrated in FIG. 9A is output as the first function executing screen 933.

According to various embodiments, the electronic device may output the notification object 950 in a designated area of the first area 910 when a selection input event of a designated function included in the first function executing screen 933 is generated. If a designated function object 933a of at least one function object included in the first function executing screen 933 is selected, the electronic device may terminate the output of the first function executing screen 933 in the first area 910 and output an execution screen (the second function executing screen 935) of the selected function object 933a. Further, the electronic device may output the notification object 950 in a designated area of the first area 910. The drawing illustrates a stage in which a reply function object (for example, a replay button) is selected from the received mail content display screen and a replay function executing screen is output in the first area 910. When the reply function executing screen is output, a soft input panel 937 (for example, a QWERTY keyboard) may be output in a designated area of the display 900 together. In this case, a length obtained by subtracting the width or height of the soft input panel 937 from at least one of the width or the height of the notification object 950. The drawing illustrates a state in which the height of the notification object 950 is generated by subtracting the height of the soft input panel 937 from the height of the display 900 and is output.

According to various embodiments, if the display 900 is expanded, the electronic device may output information related to the execution screen of the selected function object 933a in the second area 970. The drawing illustrates a state in which the electronic device outputs a first function executing screen 933 in the second area 970. Through this, when a replay to a selected mail is written through the second function executing screen 935, the contents of the selected mail may be identified through the first function executing screen 933. If the display 900 is expanded by a designated size or more, the electronic device may terminate the output of the notification object 950. In some embodiments, when additional information, which is to be output on at least a part of the first area 910 or the second area 970, is present, the electronic device may maintain the output of the notification object 950. In this case, the electronic device may constitute and output a color, a border, a shape, and a transparency of the notification object 950 or a color, a background color, a border, a shape, a size, and a number of the indication objects, differently based on the additional information.

According to various embodiments, if a designated event occurs while the output of the notification object 950 is terminated after the display 900 is expanded by a designated size or more, the electronic device may output the notification object 950 in at least one of the first area 910 or the second area 970. If a designated user input (for example, a touch input or a gesture input) for the notification object 950 that is output while the display 900 is expanded by a designated size or more, the electronic device may divide at least one of the first area 910 or the second area 970 into a plurality of areas having a designated width and a designated height. The drawing illustrates a state in which the second area 970 is divided into a third area 971 and a fourth area 973 through a longitudinal border line.

According to various embodiments, the electronic device may output corresponding screens in the divided areas. FIG. 9B illustrates a state in which the electronic device outputs a first function executing screen 933 output in the second area 970 in the third area 971, and outputs a third function executing screen 939 in the fourth area 973. The third function executing screen 939 may be a screen corresponding to an event that is generated while the display 900 is expanded by a designated size or more. For example, the third function executing screen 939 may be a screen corresponding to the generation of a selection input event of a designated function included in the second function executing screen 935. As in FIG. 9B, the electronic device may output a picture list display screen of a picture album application in the fourth area 973 in response to an attached file adding function selection input included in the reply function executing screen.

According to various embodiments, the electronic device may output the notification object 950 in a designated area of the display 900 if a designated event occurs even in a state in which at least a part of at least one of the first area 910 or the second area 970 is divided such that different screens are output in the areas. Further, the electronic device may divide at least one of the divided areas into a plurality of areas. For example, the electronic device may divide the fourth area 973 into a fifth area 991, a sixth area 993, a seventh area 995, and an eighth area 997 through at least one transverse border line. The electronic device may output content related to the first function, the second function, or the third function in the newly divided areas, or may output content that are irrelevant to the first function, the second function, or the third function. FIG. 9B illustrates a state in which the electronic device outputs a recommended application list in the areas. For example, the electronic device may output a camera application, a file search application, a note application, and a dictionary application item in the fifth area 991, the sixth area 993, the seventh area 995, and the eighth area 997. The electronic device may sequentially designate a list of the applications output in the areas based on the priority information through the setting information of the electronic device.

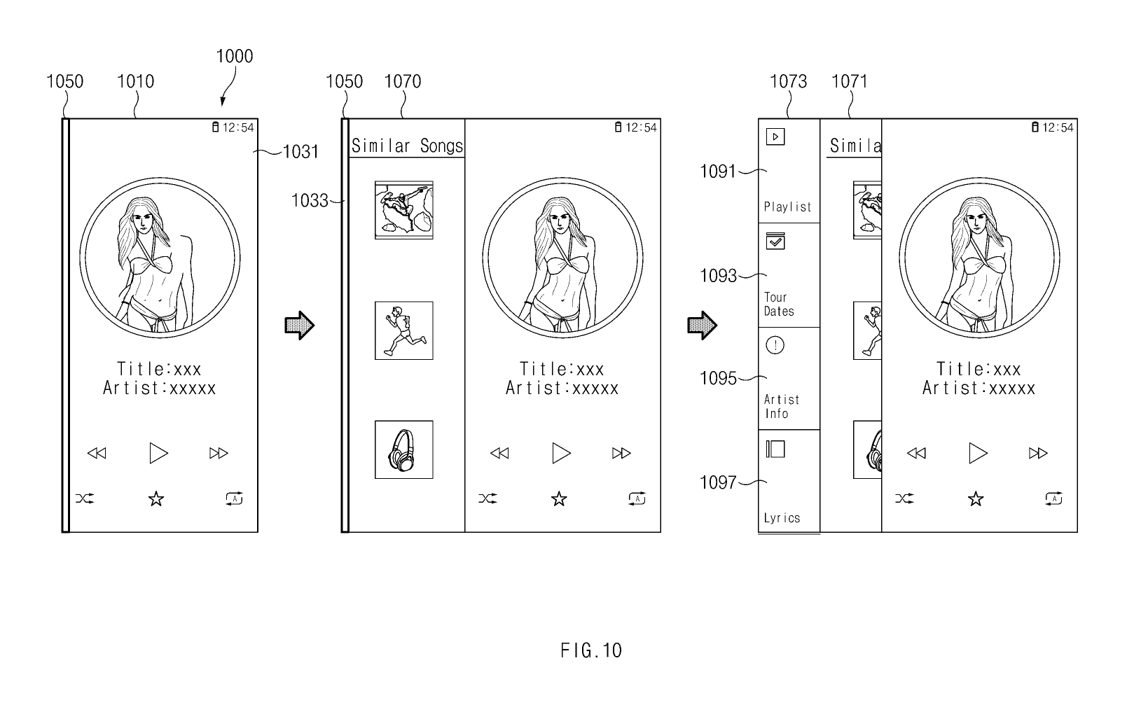

FIG. 10 illustrates a notification object provided in relation to execution of a designated application according to various embodiments of the present disclosure.

Referring to FIG. 10, the electronic device 101 may output a designated application executing screen in the first area 1010 of the display 1000. The designated application may be an application that outputs at least one content (for example, a text, an image, an audio, or a video) of at least one application included in the electronic device. For example, the designated application may be an audio reproducing application, a video reproducing application, or a picture album application.

According to various embodiments, the electronic device may output a screen 1031 of the contents stored in a memory 130 of FIG. 1 through execution of the designated application or collected by an external electronic device connected in a wired/wireless communication in the first area 1010. The drawing illustrates a state in which a reproduction screen of a designated sound source is output in the first area 1010 when an audio reproducing application is executed. The electronic device may output a screen 1031 of the content in the first area 1010, and may output the notification object 1050 in a designated area of the first area 1010 at a time interval at the same time. The electronic device may map connection (or activation) information of an output unit (for example, an audio unit) for outputting the content with a system event. The electronic device may output the notification object 1050 in a designated area of the first area 1010 when a designated system event occurs.

According to various embodiments, the electronic device may output an information screen 1033 related to the content in the second area 1070 as the display 1000 is expanded. For example, the electronic device may output an information (for example, a genre, an artist, a theme, a music name, a file name, a release time, or a storage time) screen of the content in the second area 1070. Further, the electronic device may output a recommended screen of the content having information similar to, or the same as, the information of the content in the second area 1070. The drawing illustrates a state in which the electronic device outputs a screen that recommends music sources of a genre similar to the currently reproduced music source in the second area 1070. The information screen 1033 related to the content that is output in the second area 1070 may be scrolled in response to a user input. Further, if designated information is selected from at least one information element (for example, sound source element) included in the information screen 1033 related to the content, the electronic device may output a screen corresponding to the selected information in the first area 1010.

According to various embodiments, the electronic device may divide the second area 1070 into a plurality of areas. For example, the electronic device may divide the second area 1070 into a third area 1071 and a fourth area 1073. Further, the electronic device may divide the fourth area 1073 into a fifth area 1091, the sixth area 1093, the seventh area 1095, and the eighth area 1097.

According to various embodiments, the electronic device may output a screen related to at least one of an output screen 1031 of the content or an information screen 1033 related to the content in the divided areas. The drawing illustrates a state in which the electronic device outputs a screen that recommends sound sources of a genre similar to the currently reproduced sound source and outputs a reproduction item list, a local performance schedule, artist information, and a lyrics information screen in the fifth area 1091, the sixth area 1093, the seventh 1095, and the eighth area 1097.

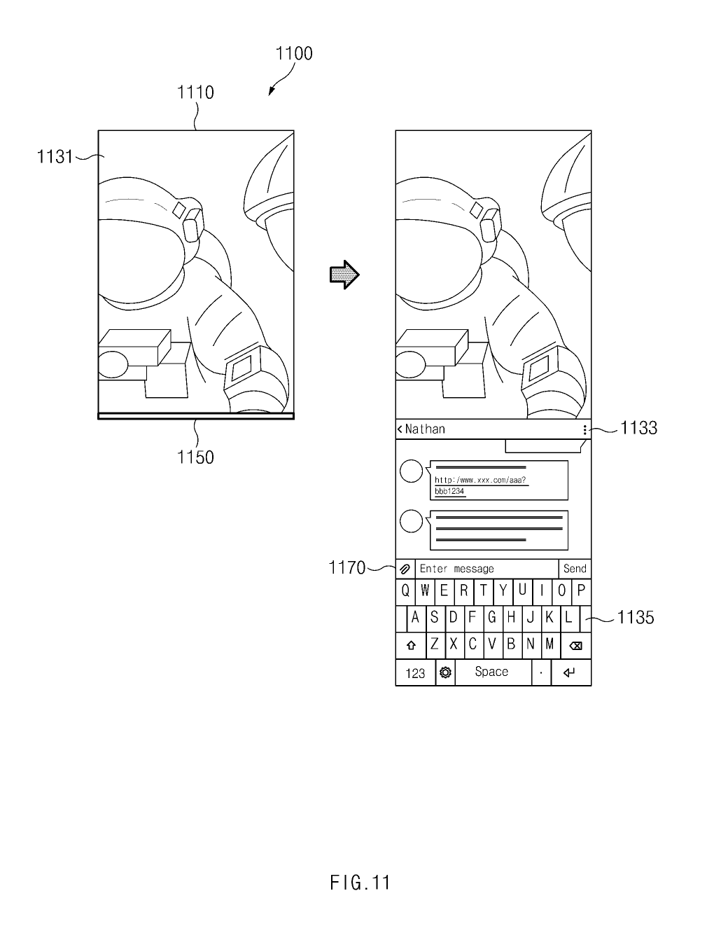

FIG. 11 illustrates a notification object provided when a communication event occurs according to various embodiments of the present disclosure.

Referring to FIG. 11, the electronic device 101 may output an execution screen 1131 of a first application in the first area 1110 that is a display area before expansion of the display 1100. The drawing illustrates a state in which the electronic device outputs an execution screen of a video reproducing application in the first area 1110. According to various embodiments, the electronic device may output the notification object 1150 in a designated area of the first area 1110 when a communication event occurs. The communication event, for example, may be an event that is generated when the electronic device transmits and receives data to and from an external electronic device. The electronic device may output the notification object 1150 in a designated area of the first area 1110 when an incoming call, a message, or various content are received.

According to various embodiments, the electronic device may output information related to the communication event in the second area 1170 as the display 1100 is expanded. For example, the electronic device may output an execution screen 1133 of the second application related to the communication event in the second area 1170. FIG. 11 illustrates a state in which the electronic device outputs an execution screen of a message application in the second area 1170. The electronic device may transfer information contained in the communication event to a second application. In this case, the second application may allow an execution screen corresponding to the information contained in the communication event to be output. FIG. 11 illustrates a state in which the second application outputs a screen of transmitting and receiving a message to and from the communication target by using information (for example, a communication target, a communication time, or communication data) contained in the communication event. In some embodiments, the electronic device may output a soft input panel 1135 in a designated area of the second area when the execution screen 1133 of the second application is output.

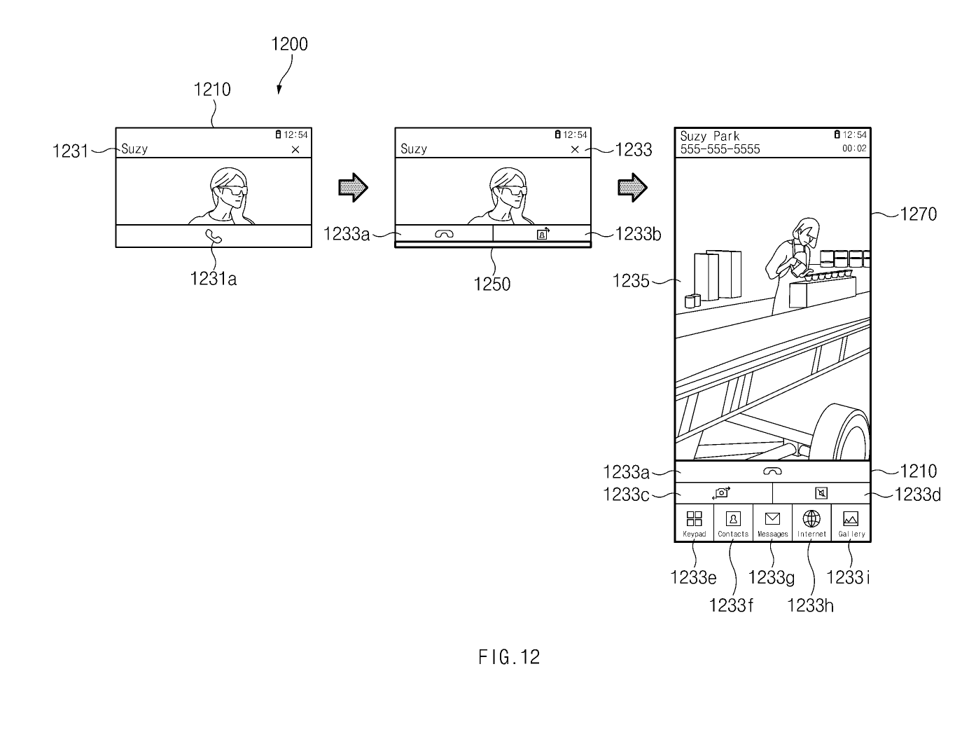

FIG. 12 illustrates a notification object provided when a system event occurs according to various embodiments of the present disclosure.

Referring to FIG. 12, the electronic device 101 may output an execution screen 1231 of a first application in the first area 1200 that is a display area before expansion of the display 1210. The drawing illustrates a state in which the electronic device outputs an execution screen of a communication application in the first area 1210. According to various embodiments, the electronic device may be communication-linked to an external electronic device that is set as a communication target when a voice communication button 1231a is selected. In this case, the electronic device may convert the execution screen of the communication application to a communication link function screen 1233. The communication link function screen 1233 may include a voice communication terminating button 1233a and a video communication converting button 1233b.

According to various embodiments, the electronic device may activate a camera module included in the electronic device when the video communication converting button 1233b is selected. The electronic device may map information corresponding to activation of the camera module as a system event if the camera module is activated. The electronic device may output the notification object 1250 in a designated area of the first area 1210 when a designated system event occurs. According to various embodiments, the electronic device may output the notification object 1250 in a designated area of the first area 1210 before the camera module is activated, when the video communication converting button 1233b is selected.

According to various embodiments, the electronic device may output information related to the system event in the second area 1270 as the display 1200 is expanded. For example, the electronic device may output an execution screen 1235 of the second application related to the system event in the second area 1270. The drawing illustrates a state in which the electronic device outputs an execution screen of a camera application in the second area 1270. The execution screen of the camera application may be included in an execution screen of the communication application. For example, when the electronic device performs a video communication function through a communication application, it may dispose a video communication screen of the communication application by transferring a video photographed through the camera module to the communication application. The video communication screen may be displayed in at least a part of the second area 1270 including the first area 1210.

According to various embodiments, the electronic device may output an execution screen 1235 of a second application in the second area 1270, and may change an execution screen 1231 of a first application output in the first area 1210 at a designated time interval. The electronic device may change the screen when the execution function of the first application is changed. For example, the electronic device may change the display objects included in the communication link function screen 1233 from a voice communication function object to a video communication function object, when an execution function is changed from a voice communication application to a video communication function. FIG. 12 illustrates a state in which the electronic device outputs function buttons such as a voice communication terminating button 1233a, a camera converting button 1233c, a communication volume level adjusting button 1233d, a soft input panel display button 1233e, a contact address search button 1233f, a message application executing button 1233g, a web browser executing button 1233h, or a picture album application executing button 1233i in the first area 1210.

According to various embodiments, an electronic device may include a flexible display having a deformable form, a processor electrically connected to the display, and a memory electrically connected to the processor, and the memory may store instructions that allows the processor to output a notification object that provides notification that information, which is to be output on at least a part of a second area of the display expanded according to deformation of the form of the display when an event occurs, is present in a first area corresponding to an area before expansion of the display during execution of the processor.

According to various embodiments, the instructions may allow the processor to output the notification object in an area, which is situated on a side close to a side on which the display is expanded, on an edge of the first area.

According to various embodiments, the instructions may allow the processor to constitute at least one of display configuration of the notification object and display configuration of at least one indication object included in the notification object differently based on at least one of a type of the event, a type of the information, a number of the information, an expansion direction of the display, and an expansion degree of the display. The display configuration may include at least one of a width, a height, a color, a background color, a border, a shape, and a transparency.

According to various embodiments, when the display is expanded by at least a size or more, the instructions may allow the processor to output information indicated by the notification object on at least a part of the second area.

According to various embodiments, the instructions may allow the processor to output another notification object in at least one of the first area and the second area in response to another event when the display is expanded by a size or more.

According to various embodiments, when a user input for the another notification object occurs, the instructions may allow the processor to divide at least one of the first area and the second area into a plurality of areas and output information indicated by the another notification object in at least one of the divided areas.

According to various embodiments, when a selection input of an object of at least one display object included in a first screen outputted in the first area occurred, the instructions may allow the processor to output a second screen related to the selected object in the first area and output the first screen on at least a part of the second area.

According to various embodiments, when an application, by which at least one content is output, is executed, the instructions may allow the processor to output an output screen of the at least one content in the first area and output a screen containing information of at least another content related to the at least one content on at least a part of the second area.

According to various embodiments, the instructions may allow the processor to output information, which corresponds to a communication related input signal occurred while the electronic device communicates with an external electronic device, at least a part of the second area in response to the communication related input signal.

According to various embodiments, the instructions may allow the processor to output information, which corresponds to a control input signal of at least one system element constituting a platform of the electronic device or connected to the platform, on at least a part of the second area in response to the control input signal.

According to various embodiments, a method for providing a notification of usability for an expandable area of a display of an electronic device may include analyzing an event in response to occurrence of the event, identifying a form factor of the display, generating a notification object that provides notification that information, which is to be output on at least a part of a second area of the display expanded according to deformation of the form of the display, is present, and outputting the notification object in a first area that is an area before expansion of the display.

According to various embodiments, the outputting of the notification object may include outputting the notification object in an area, which is situated on a side close to a side on which the display is expanded, on an edge of the first area.

According to various embodiments, the generating of the notification object may include constituting at least one of display configuration of the notification object and display configuration of at least one indication object included in the notification object differently based on at least one of a type of the event, a type of the information, a number of the information, an expansion direction of the display, and an expansion degree of the display. The display configuration may include at least one of a width, a height, a color, a background color, a border, a shape, and a transparency.

According to various embodiments, when the display is expanded by a size or more, the method may include outputting information indicated by the notification object on at least a part of the second area.

The outputting of the notification object includes outputting another notification object in at least one of the first area and the second area in response to occurrence of another event when the display is expanded by a size or more.

According to various embodiments, the outputting of the another notification object may further include when a user input for the another notification object occurs, dividing at least one of the first area and the second area into a plurality of areas, and outputting information indicated by the another notification object in at least one of the divided areas.

According to various embodiments, the outputting of the notification object may include when a selection input of an object of at least one display object included in a first screen outputted in the first area occurred, outputting a second screen related to the selected object in the first area and outputting the first screen on at least a part of the second area.

According to various embodiments, the outputting of the notification object may include when an application that outputs at least one content is executed, outputting an output screen of the at least one content in the first area, and outputting a screen containing at least another content related to the content on at least a part of the second area.

According to various embodiments, the outputting of the notification object may include outputting information, which corresponds to a communication related input signal occurring while the electronic device communicates with an external electronic device, on at least a part of the second area in response to the communication related input signal.

According to various embodiments, the outputting of the notification object may further include outputting information, which corresponds to a control input signal of at least one system element constituting a platform of the electronic device or connected to the platform, on at least a part of the second area, in response to the control input signal.

The term “module” as used in the specification may mean a unit including, for example, one of hardware, software, or firmware or a combination of two or more of them. The term module may be interchangeably used, for example, a unit, a logic, a logical block, a component, or a circuit. The module may be a minimum unit or a part of an integrally configured part. The module may be a minimum unit or a part which performs one or more functions. The module may be implemented mechanically or electromagnetically. For example, the module may include at least one of an application-specific integrated circuit (ASIC) chip, a field-programmable gate array, or a programmable-logic device, which has been known, will be developed in the future, or performs certain operations.

At least some of the devices (for example, modules or functions) or methods (for example, operations) according to various embodiments of the present disclosure may be implemented by an instruction stored in a non-transitory computer-readable storage medium, for example, in the form of a program module. When the instruction is executed by the processor (for example, the processor 120), the at least one processor may perform a function corresponding to the instruction. The non-transitory computer-readable storage medium may be, for example, a memory 130.

The non-transitory computer-readable storage medium may include a hard disk, a floppy disk, a magnetic medium (for example, a magnetic tape), an optical medium (for example, a compact disk read only memory (CD-ROM)), a digital versatile disk (DVD), a magnetic-optical medium (for example, a floptical disk), a hardware device (for example, a read only memory (ROM), a random access memory (RAM), or a flash memory). Further, the program instructions may include high-level language codes which may be executed by a computer using an interpreter as well as machine languages created by using a compiler. The above-mentioned hardware device may be configured to be operated as one or more software module to perform operations of various embodiments, and the converse is true.

The module or program module according to various embodiments of the present disclosure may include at least one of the above-mentioned element, omit some of them, or further include other elements. The module, the program module, or the operations performed by other elements may be performed in a sequential, parallel, iterative, or heuristic method. Further, some operations may be executed in another sequence or may be omitted, or other operations may be added.

According to various embodiments, the user may expand a display by outputting a notification object that provides notification that information, which is to be output in an expandable area of the display when a designated event occurs, thereby improving the usability of the expandable area of the display.

According to various embodiments, a preliminary recognition for output information may be improved by constituting a notification object differently based on a type of an event, a type and a number of output information, or an expansion direction and an expansion degree of the display.

Further, the embodiments disclosed in the specification are provided to describe the technical contents or for understanding of the technical contents, and the technical scope of the present disclosure is not limited thereto. Accordingly, the scope of the present disclosure should be construed to include all changes or various embodiments based on the technical spirit of the present disclosure as defined by the appended claims and their equivalents.

What is claimed is:

1. An electronic device comprising:
a flexible display having a deformable form;
a processor electrically connected to the display; and
a memory electrically connected to the processor,
wherein the processor is configured to display a notification object that provides notification about an existence of information, which is to be displayed on at least a part of a second area of the display expanded according to deformation of the display when an event occurs, on a first area before expansion of the display.

2. The electronic device of claim 1, wherein the processor is further configured to display the notification object in an area close to a side on which the display is expanded.

3. The electronic device of claim 1, wherein the processor is further configured to constitute at least one of display configuration of the notification object and display configuration of at least one indication object included in the notification object based on at least one of a type of the event, a type of the information, a number of the information, an expansion direction of the display, and an expansion degree of the display, and wherein the display configuration includes at least one of a width, a height, a color, a background color, a border, a shape, and a transparency.

4. The electronic device of claim 1, wherein, when the display is expanded, the processor is further configured to display the information indicated by the notification object on at least a part of the second area.

5. The electronic device of claim 1, wherein the processor is further configured to display another notification object on at least one of the first area and the second area in response to another event when the display is expanded.

6. The electronic device of claim 5, wherein, when a user input for the another notification object occurs, the processor is further configured to divide at least one of the first area and the second area into a plurality of areas and display information indicated by the another notification object on at least one of the divided areas.

7. The electronic device of claim 1, wherein, when a selection input of an object included in a first screen displayed in the first area occurs, the processor is further configured to display a second screen related to the selected object in the first area and display the first screen on at least a part of the second area.

8. The electronic device of claim 1, wherein, when an application, by which at least one content is displayed, is executed, the processor is further configured to display the at least one content in the first area and display information of at least one other content related to the at least one content on at least a part of the second area.

9. The electronic device of claim 1, wherein the processor is further configured to display information, which corresponds to a communication related input, on at least a part of the second area in response to the communication related input.

10. The electronic device of claim 1, wherein the processor is further configured to display information, which corresponds to a control input, on at least a part of the second area in response to the control input.

11. A method for providing a notification on an expandable area of a display of an electronic device, the method comprising:
analyzing an event;
identifying a form factor of the display;
generating a notification object that provides notification about an existence of information, which is to be displayed on at least a part of a second area of the expandable area of the display; and
displaying the notification object on a first area before expansion of the display.

12. The electronic device of claim 11, wherein displaying the notification object comprises displaying the notification object in an area close to a side on which the display is expanded.

13. The electronic device of claim 11, wherein generating the notification object comprises constituting at least one of a display configuration of the notification object and a display configuration of at least one indication object included in the notification object based on at least one of a type of the event, a type of the information, a number of the information, an expansion direction of the display, and an expansion degree of the display, and
wherein the display configuration includes at least one of a width, a height, a color, a background color, a border, a shape, and a transparency.

14. The electronic device of claim 11, further comprising, when the display is expanded, displaying the information indicated by the notification object on at least a part of the second area.

15. The electronic device of claim 11, wherein displaying the notification object comprises displaying another notification object on at least one of the first area and the second area in response to another event when the display is expanded.

16. The electronic device of claim 15, wherein displaying the another notification object further comprises:
when a user input for the another notification object occurs, dividing at least one of the first area and the second area into a plurality of areas; and
displaying information indicated by the another notification object in at least one of the plurality of areas.

17. The electronic device of claim 11, wherein displaying the notification object comprises:
when a selection input of an object included in a first screen displayed in the first area occurs, displaying a second screen related to the selected object in the first area; and
displaying the first screen on at least a part of the second area.

18. The electronic device of claim 11, wherein displaying the notification object comprises:
when an application that displays at least one content is executed, displaying the at least one content in the first area; and
displaying at least one other content related to the at least one content on at least a part of the second area.

19. The electronic device of claim 11, wherein displaying the notification object comprises displaying information, which corresponds to a communication related input, on at least a part of the second area in response to the communication related input.

20. The electronic device of claim 11, wherein displaying the notification object comprises displaying information, which corresponds to a control input, on at least a part of the second area, in response to the control input.
